(19) United States
(12) Patent Application Publication
(10) Pub. No.: US 2008/0175407 A1
(43) Pub. Date: Jul. 24, 2008

(54) SYSTEM AND METHOD FOR CALIBRATING PHASE AND GAIN MISMATCHES OF AN ARRAY MICROPHONE

(75) Inventors: Ming Zhang, Cupertino, CA (US); Xiaoyan Lu, Nanjing (CN); Lili Chen, Nanjing (CN); Jing Ding, Nanjing (CN); Bo Zhang, Nanjing (CN)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: FORTEMEDIA, INC., Cupertino, CA (US)

(21) Appl. No.: 11/625,840

(22) Filed: Jan. 23, 2007

(51) Int. Cl. H04R 3/00

(52) U.S. Cl. 381/92

(57) ABSTRACT

The invention provides a system for calibrating phase and gain mismatches of an array microphone. The array microphone is installed in a voice interface device and comprises a plurality of microphones. The system comprises a loudspeaker and a computing equipment. The loudspeaker plays a segment of sound to be received by the array microphone. The computing equipment controlls the voice interface device which converts the segment of sound to a plurality of audio signals with the microphones of the array microphone, records the audio signals outputted by the voice interface device at bypass mode without any signal processing, calculates delays between the audio signals, and instructs the voice interface device to adjust phase mismatches between the audio signals according to the delays.

### BACKGROUND OF THE INVENTION

1. Field of the Invention

The invention relates to array microphones, and more particularly to production line calibration of voice interface devices including array microphones.

2. Description of the Related Art

A single microphone only capable of receive sound from all directions with uniform gain is referred to as an omni-directional microphone. An omni-directional microphone used to receive a target voice from a single direction, simultaneously receives other surrounding noises coming from other directions. Thus, surrounding noise captured with the target voice degrades voice quality.

An array microphone including a plurality of microphones, prevents the described deficiency of an omni-directional microphone by receiving a target sound at different locations. Thus there are small differences between the phases and amplitudes of signals received by the microphones, caused by receiving sound at different locations. Thus, the array microphone can identify the target sound coming from a specific direction according to the phase and amplitude differences, and suppress surrounding noise coming from other directions. Such an array microphone is referred to as a “directional microphone”, because it is capable of capturing sound from a specific direction.

For this reason, the phase and amplitude differences of audio signals received by the microphones in an array microphone are crucial for the extraction of the target sound. The phase and amplitude differences, however, are not always caused by the differences in sound received by the microphones at different locations. The component mismatches between the microphones and the input circuits thereof also induce the phase and amplitude differences of the audio signals. For example, the capacitance difference between diaphragms of different microphones may cause a delay in the audio signals, and the resistance difference of the input circuits of the microphones may cause gain difference in the audio signals. If such phase and amplitude differences are used to extract the target sound coming from a specific direction, the derived target sound may be erroneous. Hence, the phase and amplitude differences induced by component mismatches significantly affect the performance of an array microphone. It is very difficult, however, to fabricate an array microphone with identical microphones. Thus, a method for calibrating phase and gain mismatches during fabrication of an array microphone is desirable.

### BRIEF SUMMARY OF THE INVENTION

The invention provides a system for calibrating phase and gain mismatches of an array microphone. The array microphone is installed in a voice interface device and comprises a plurality of microphones. The system comprises a loudspeaker and a computing equipment. The loudspeaker plays a segment of sound to be received by the array microphone. The computing equipment controls the voice interface device which converts the segment of sound to a plurality of audio signals with the microphones of the array microphone, records the audio signals outputted by the voice interface device at bypass mode without any signal processing, calculates delays between the audio signals, and instructs the voice interface device to adjust phase mismatches between the audio signals according to the delays.

The invention also provides a method for calibrating phase and gain mismatches of an array microphone. The array microphone is installed in a voice interface device and comprises a plurality of microphones. First, a segment of sound to be received by the array microphone is played. The voice interface device is then controlled to bypass audio signals converted from the sound by the microphones of the array microphone. The audio signals output by the voice interface device are then recorded. Correlation coefficients based on correlation of the audio signals is then calculated. Delays between the audio signals are then determined according to the correlation coefficients. Finally, the voice interface device is instructed to adjust phase mismatches between the audio signals according to the delays.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a block diagram of a system for calibrating phase and gain mismatches of array microphones according to the invention;

FIG. 2 is a flowchart of a method for calibrating phase and gain mismatches of array microphones according to the invention;

FIG. 3 is a flowchart of a system calibrating the gain and phase mismatches of a voice interface device according to the invention;

FIG. 4 is a flowchart of another system calibrating the gain and phase mismatches of a voice interface device according to the invention; and

FIG. 5 is a flowchart of a phase and gain mismatch calibration method on the basis of sub-band analysis according to the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

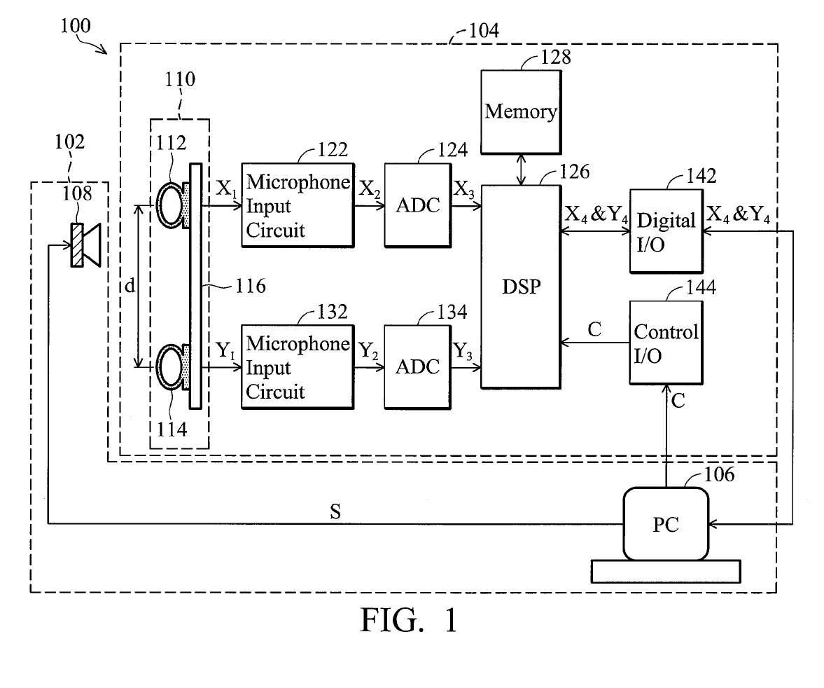

FIG. 1 is a block diagram of a system 102 for calibrating phase and gain mismatches of array microphones according to the invention. The system 102 includes a computing equipment 106 and a loudspeaker 108, and is used to calibrate the array microphone 110 of a voice interface device 104 during production of the voice interface device 104 on a production line. For example, the voice interface device 104 may be a Bluetooth earphone, a GPS hands-free speakerphone, or a hands-free car kit, or cellphone or PC, etc. The voice interface device 104 includes an array microphone 110, which further comprises two omni-directional microphones, 112 and 114, separated by a distance d. The computing equipment 106 may be a computer or a microcontroller.

In addition to the microphone array 110, the voice interface device 100 also includes two microphone input circuits 122 and 132, two analog to digital converters 124 and 134, a digital signal processor 126, a memory 128, a digital I/O interface 142, and a control I/O interface 144. The omni-directional microphones 112 and 114 first respectively convert a received sound to audio signals X₁ and Y₁. The audio signals X₁ and Y₁ are then respectively amplified and filtered by the microphone input circuits 122 and 132 to obtain the audio signals X₂ and Y₂, which are further converted to digital audio signals X₃ and Y₃ by analog to digital converters 124 and 134.

The digital signal processor 126 can then process the audio signals X₃ and Y₃ to obtain the audio signals X₄ and Y₄ according to instructions of the computing equipment 106. The computing equipment 106 is connected to the voice interface device 104 via two interfaces: the digital I/O interface 142 and the control I/O interface 144. The audio signals X₄ and Y₄ can be transmitted to the computing equipment 106 through the digital I/O interface 142. The computing equipment 106 sends instructions to control the digital signal processor 126 via the control I/O interface 144. Although the array microphone 110 includes only two omni-directional microphones, the system 102 can be used to calibrate a voice interface device 104 including a microphone array containing more than two omni-directional microphones.

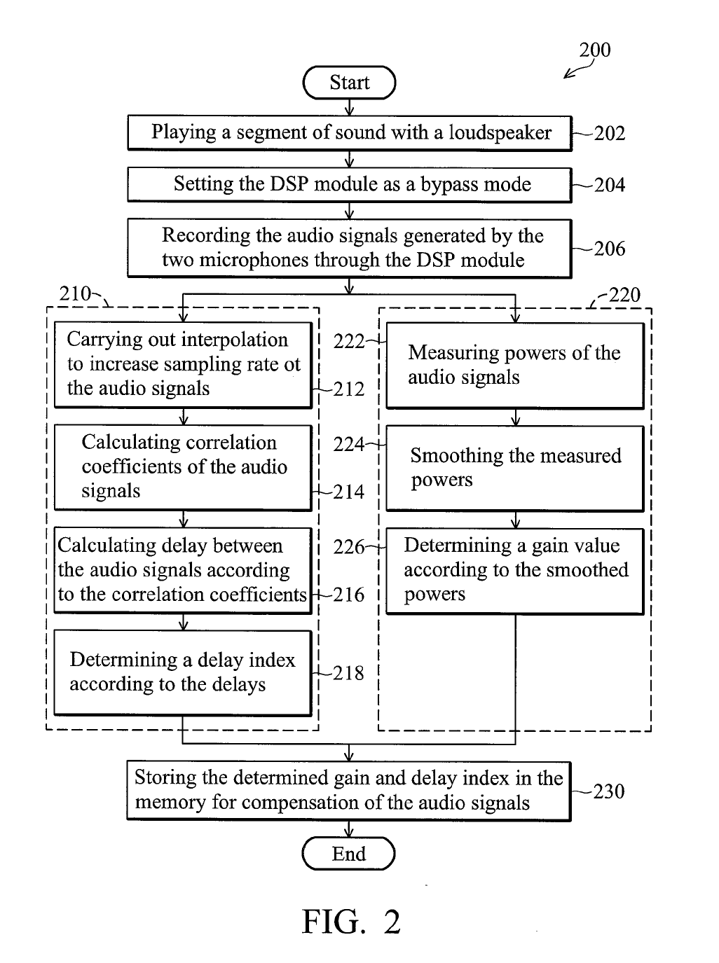

To illustrate the calibration process of the system 100, a method 200 for calibrating phase and gain mismatches of array microphones according to the invention is provided in FIG. 2. The computing equipment 106 functions according to method 200 to calibrate the voice interface device 100. First, the computing equipment 106 controls the loudspeaker 108 to play a segment of sound in step 202, wherein the loudspeaker 108 is put at the same distances to the two microphones 112 and 114. At the same time, the computing equipment 106 also sets the digital signal processor 126 as a bypass mode in step 204. When the loudspeaker 108 plays the sound, the microphones 112 and 114 respectively converts the sound to audio signals X₁ and Y₁, and the audio signals X₁ and Y₁ are then processed by the microphone input circuits and the analog to digital converters to form audio signals X₃ and Y₃. In bypass mode, the digital signal processor 126 directly bypasses the audio signals X₃ and Y₃ to be output to the computing equipment 106 as the audio signals X₄ and Y₄. Thus, the audio signals X₄ and Y₄ only comprise phase and gain mismatches induced by the microphones 112 and 114, the input circuits 122 and 132, and the analog to digital converters 124 and 134, and can be recorded by the computing equipment 106 for further analysis in step 206.

The recorded audio signals X₄ and Y₄ are then analyzed by the computing equipment 106 in two different analysis paths. One analysis path 210 is to determine the phase mismatch between the audio signals X₄ and Y₄, and the other analysis path 220 is to determine the gain mismatch between the audio signals X₄ and Y₄. With regard to phase mismatching, because the sampling rate of analog to digital converters 124 and 134 may be lower, the computing equipment 106 first interpolates the audio signals in step 210 to increase the sampling rate of the audio signals fitting the requirement for delay calculation with enough precision. The interpolated audio signals are then used to calculate cross-correlation coefficients in step 214. A delay between the samples of the audio signals can then be determined according to the correlation coefficients in step 216. Because the loudspeaker 108 is separated by the same distance from microphones 112 and 114, the sound is delayed by the same amount prior to reception by the microphones, thus, no phase mismatching exists between the audio signals. Thus, the delay between the audio signals is caused completely by component mismatch of the microphones themselves, the input circuits thereof, and the ADCs. A set of predetermined delay values may be stored in the memory 128 in advance, and a delay index can be determined in step 218 to select a delay value nearest the delay calculated in step 216 from the set of delay values. Thus, after the delay index is delivered to the digital signal processor 126, the digital signal processor 126 can then delay the samples of the audio signals X₃ or Y₃ according to the delay index, and the audio signals X₄ and Y₄ without phase mismatching.

The gain mismatch is determined in the analysis path 220. The computing equipment 106 first measuring the powers of the audio signals X₄ and Y₄ in step 222. The measured powers are then smoothed in step 224 to obtain average powers of the audio signals. Because the loudspeaker 108 is separated from the microphones 112 and 114 by the same distance, the sound suffers the same amount of attenuation before being received by the microphones, thus, no amplitude mismatching exists between the audio signals. Thus, the power difference between the audio signals is caused completely by component mismatching of the microphones, the input circuits thereof, and the ADCs. A gain value can then be determined according to the smoothed powers in step 226. After the gain value is delivered to the digital signal processor 126, the digital signal processor 126 can then amplify the samples of the audio signals X₃ or Y₃ according to the gain value to compensate for the gain mismatch, and the audio signals X₄ and Y₄ without gain mismatching is obtained.

Moreover, the delay and the gain calculated in steps 218 and 226 can be further used to determine a set of filtering coefficients for compensating the phase and gain mismatches of the audio signals X₃ and Y₃. The filtering coefficients can be stored in the memory 128, and the digital signal processor 126 then filters the audio signals X₃ and Y₃ according to the filtering coefficients to obtain the audio signals X₄ and Y₄ without phase and gain mismatches. In one embodiment, multiple sets of filtering coefficients are stored in the memory 128 in advance, and the computing equipment 106 simply determines a filtering coefficient index which selects an appropriate set of filtering coefficients from the multiple sets of filtering coefficients, and the digital signal processor 126 can then filter the audio signals X₃ and Y₃ according to the filtering coefficient index to remove the phase and gain mismatches.

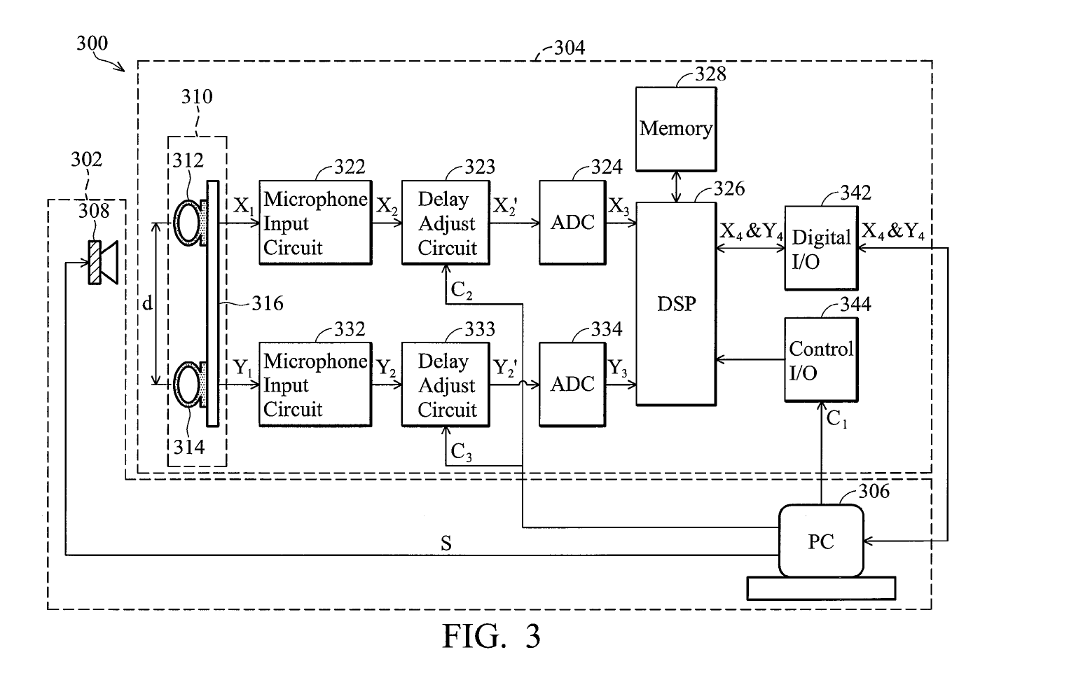

FIG. 3 is a flowchart of a system 302 calibrating the gain and phase mismatches of a voice interface device 304 according to the invention. Two adjustment circuits 323 and 333 are added to the voice interface device 304. After the delay and gain are determined in the step 216 and 226 of FIG. 2, the adjustment circuits 323 and 333 can directly delay the audio signals X₂ and Y₂ and amplifies the audio signals X₂ and Y₂ according to the computer instructions C₂ and C₃, thus obtaining audio signals X₂′ and Y₂′ without phase and gain mismatches.

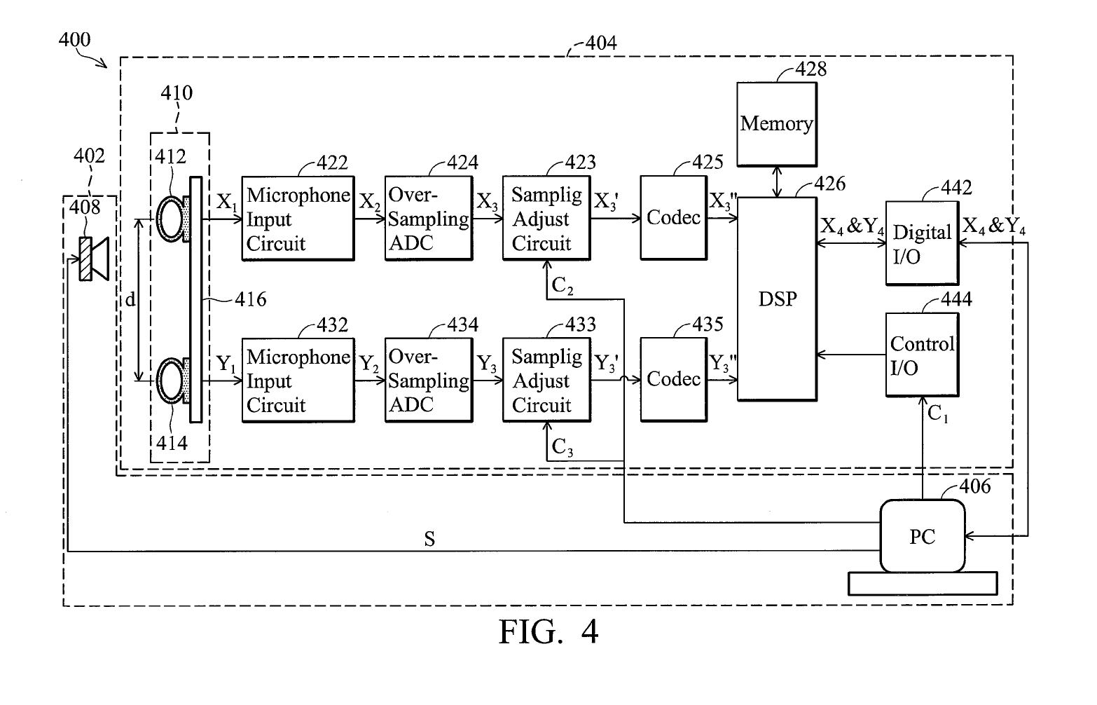

FIG. 4 is a flowchart of another system 402 calibrating the gain and phase mismatches of a voice interface device 404 according to the invention. The analog to digital converters 424 and 434 of the voice interface device 404 are converts the audio signals X₂ and Y₂ with a high sampling rate to obtain the audio signals X₃ and Y₃. Two sampling adjustment circuits 423 and 433 are added to the voice interface device 404. After the delay is determined in the step 216 of FIG. 2, the sampling adjustment circuits 423 and 433 directly delay the audio signals X₃ and Y₃ according to the computer instructions C₂ and C₃, thus, audio signals X₃′ and Y₃′, without phase mismatches, are obtained.

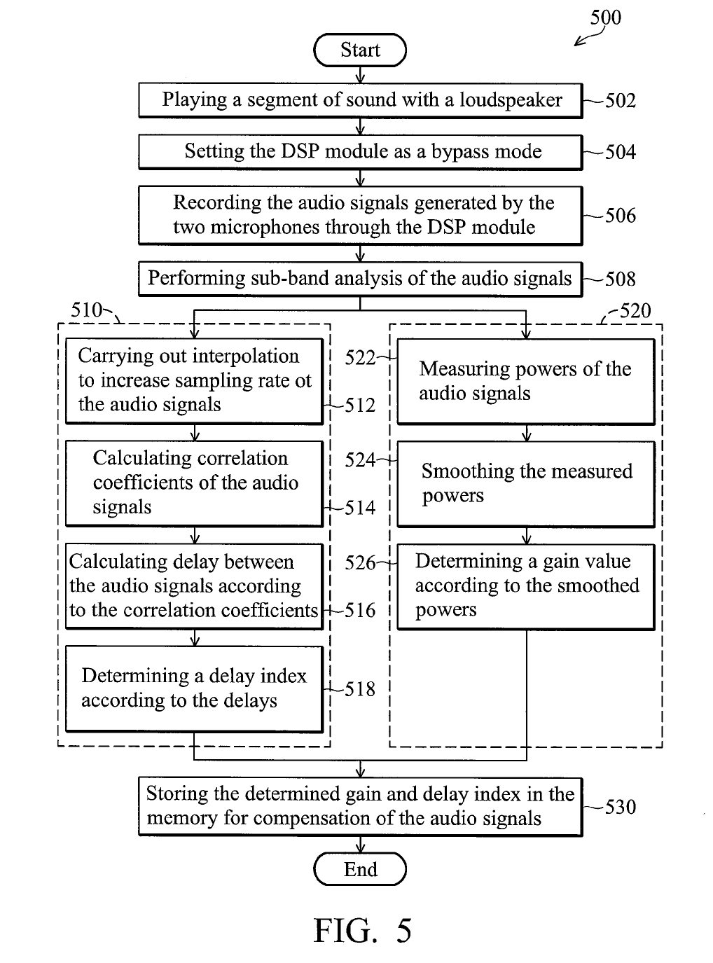

FIG. 5 is a flowchart of a phase and gain mismatch calibration method 500 on the basis of sub-band analysis according to the invention. Method 500 is roughly similar to method 200 of FIG. 2, except for step 508. A sub-band analysis is performed on the audio signals in step 508, and the delay and gain are determined on the basis of the sub-band analysis of step 508. Thus, a sub-band calibration can be performed to remove the phase and gain mismatches. Although the sub-band calibration 500 requires more computation and is more complicated, the sub-band calibration 500 can remove phase and gain mismatches with better precision.

The invention provides a method for calibrating phase and gain mismatches of an array microphone. Because the phase and gain mismatches are calibrated when array microphones are fabricated, signals generated by the array microphones will not comprise the delay and attenuation caused by component mismatches of the microphones and the input circuits thereof. Thus, beam-forming can be precisely performed to extract in-band sounds coming from specific directions and suppress the out-of-band noise, and the performance of the voice interface devices including the array microphones is enhanced.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A system for calibrating phase and gain mismatches of an array microphone, wherein the array microphone is installed in a voice interface device and comprises a plurality of microphones, the system comprising:
a loudspeaker, playing a segment of sound to be received by the array microphone; and
a computing equipment, coupled to the loudspeaker and the voice interface device, controlling the voice interface device which converts the segment of sound to a plurality of audio signals with the microphones of the array microphone, recording the audio signals outputted by the voice interface device at bypass mode without any signal processing, calculating delays between the audio signals, and instructing the voice interface device to adjust phase mismatches between the audio signals according to the delays.

2. The system as claimed in claim 1, wherein the computing equipment is a computer or a microcontroller.

3. The system as claimed in claim 1, wherein the computing equipment calaculates correlations between the audio signals to determine the delays.

4. The system as claimed in claim 1, wherein the computing equipment further measures powers of the audio signals, determines gains of the audio signals according to difference between the powers, and instructs the voice interface device to compensate for gain mismatches between the audio signals according to the gains.

5. The system as claimed in claim 4, wherein the computing equipment calculates a plurality of filtering coefficients according to the delays and gains and stores the filtering coefficients in the voice interface device, and the voice interface device then filters the audio signals according to the filter coefficients to adjust the phase mismatches and compensate for the gain mismatches.

6. The system as claimed in claim 4, wherein a plurality of sets of filtering coefficients is stored in the voice interface device in advance, the computing equipment determines an optimum set from the sets of filtering coefficients according to the delays and gains to remove the phase mismatches and the gain mismatches from the audio signals, and the voice interface device then filters the audio signals according to the optimum set of filtering coefficients.

7. The system as claimed in claim 6, wherein the voice interface device comprises:
the microphone array, comprising the microphones, each of which converts the segment of sound to one of the audio signals;
a plurality of microphone input circuits, coupled to the microphones of the microphone array, amplifying and filtering the audio signals;
a plurality of analog to digital converters, coupled to the microphone input circuits, converting the audio signals from analog to digital forms;
a digital signal processor, coupled to the analog to digital converters and the memory, processing the audio signals according to instructions of the computing equipment;
a digital I/O interface, coupled between the digital signal processor and the computing equipment, transmitting the audio signals to the computing equipment; and
a control I/O interface, coupled between the digital signal processor and the computing equipment, forwarding the instructions of the computing equipment to the digital signal processor.

8. The system as claimed in claim 7, wherein the voice interface device further comprises a memory, coupled to the digital signal processor, storing a plurality of filtering coefficients calculated by the computing equipment according to the delays and the gains, and the digital signal processor further filters the audio signals according to the filter coefficients to adjust the phase mismatches and compensate the gain mismatches.

9. The system as claimed in claim 7, wherein the voice interface device further comprises a plurality of adjusting circuits, coupled between the microphone input circuits and the analog to digital converters, compensating the audio signals for the phase and gain mismatches respectively according to the delays and the gains.

10. The system as claimed in claim 7, wherein the analog to digital converters converts the audio signals from analog to digital forms with a high sampling rate, and the voice interface device further comprise a plurality of sample adjust circuits, coupled between the analog to digital converters and the digital signal processor, shifting samples of the audio signals to correct the phase mismatches according to the delays.

11. The system as claimed in claim 1, wherein the computing equipment further performs sub-band analysis of the audio signals on the calculation of the correlation coefficients and the measurement of the powers in order that the delays and the gains are determined on the basis of the sub-band analysis.

12. A method for calibrating phase and gain mismatches of an array microphone, wherein the array microphone is installed in a voice interface device and comprises a plurality of microphones, the method comprising:
playing a segment of sound to be received by the array microphone;
controlling the voice interface device to bypass audio signals converted from the sound by the microphones of the array microphone;
recording the audio signals output by the voice interface device;
calculating correlation coefficients based on correlation of the audio signals;
determining delays between the audio signals according to the correlation coefficients; and
instructing the voice interface device to adjust phase mismatches between the audio signals according to the delays.

13. The method as claimed in claim 12, wherein the method further comprises:
measuring powers of the audio signals;
determining gains of the audio signals according to difference between the powers; and
instructing the voice interface device to compensate for gain mismatches between the audio signals according to the gains.

14. The method as claimed in claim 13, wherein the method further comprises:
calculating a plurality of filtering coefficients according to the delays and gains; and
storing the filtering coefficients in the voice interface device;
wherein the voice interface device then filters the audio signals according to the filter coefficients to adjust the phase mismatches and compensate for the gain mismatches.

15. The method as claimed in claim 13, wherein the method further comprises
storing a plurality of sets of filtering coefficients in the voice interface device in advance; and
determining an optimum set of filtering coefficients according to the delays and gains to remove the phase mismatches and the gain mismatches from the audio signals;
wherein the voice interface device then filters the audio signals according to the optimum set of filtering coefficients.

16. The method as claimed in claim 14, wherein the voice interface device includes a memory storing the filtering coefficients, and the voice interface device further includes a digital signal processor filtering the audio signals according to the filter coefficients to adjust the phase mismatches and compensate the gain mismatches.

17. The method as claimed in claim 13, wherein the voice interface device includes a plurality of adjusting circuits compensating the audio signals for the phase and gain mismatches respectively according to the delays and the gains.

18. The method as claimed in claim 13, wherein the voice interface device includes a plurality of analog to digital converters converting the audio signals from analog to digital forms with a high sampling rate, and the voice interface device further includes a plurality of sample adjustment circuits shifting samples of the audio signals to correct the phase mismatches according to the delays.

19. The method as claimed in claim 13, wherein the method further comprises performing a sub-band analysis of the audio signals on the calculation of the correlation coefficients and the measurement of the powers in order that the delays and the gains are determined on the basis of the sub-band analysis.
